(19) United States
(12) Patent Application Publication
(10) Pub. No.: US 2002/0187219 A1
(43) Pub. Date: Dec. 12, 2002

(54) Low glycemic response compositions

(75) Inventors: David Kee Yang, Cincinnati, OH (US); Judy Ann Jones, Cleves, OH (US); Gary Allen Britting, Loveland, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Co.

(21) Appl. No.: 09/821,376

(22) Filed: Mar. 29, 2001

(51) Int. Cl. A23L 1/30

(52) U.S. Cl. 426/72

(57) ABSTRACT

The present disclosure is related to compositions useful in the field of foods and beverages. In particular, the present invention relates to those compositions that reduce the postprandial rise in blood glucose (described as low Glycemic Index) that synergistically provide enhanced metabolism in the mammalian system and inhibit the storage of systemic fat. In particular, the present invention relates to compositions comprising:

a) one or more flavanols;

b) one or more bracers; and

c) vitamin B;

wherein the composition exhibits a Glycemic Index of about 55 or less.

As disclosed, the unique combination of ingredients, which provide the defined, low Glycemic Index, work synergistically together to enhance perception of energy and/or improve physiological energy via metabolism enhancement over a long duration of time, without resulting in sudden peaks of glucose in the mammalian system. Thus, the present compositions effectively modulate glucose in the system, thereby providing energy to the system without resulting in the storage of systemic fat.

### FIELD OF THE INVENTION

The present invention relates to compositions useful in the field of foods and beverages. In particular, the present invention relates to those compositions that reduce the postprandial rise in blood glucose and synergistically act to provide enhanced metabolism in the mammalian system and inhibit the storage of systemic fat.

### BACKGROUND OF THE INVENTION

It is common for consumers to experience a period of low energy during various periods of the day. Consumers in the general population perceptually associate this negative mood state with low blood glucose levels. It has been reported that falling blood glucose levels correlate to lower self-reported energy levels while performing cognitive tasks (Owens et al, “Blood Glucose and Subjective Energy Following Cognitive Demand”, Physiology and Behavior, Vol. 62(3), pp. 471-478 (1997)). In order to restore their positive mood, consumers frequently ingest a highly sugared food or beverage (e.g., soda or a candy bar).

Unfortunately for the consumer, these sources of energy result in rapid blood sugar peaks that are not maintained over time. Such sources tend to increase the blood glucose level quickly and excessively, followed by rapid depletion of blood glucose levels. Research has shown that carbohydrate containing foods and beverages that are high in Glycemic Index (GI), e.g., soft drinks, are rapidly digested, absorbed and transformed metabolically to glucose (Jenkins et al., “Relationship Between Rate of Digestion of Foods and Post-prandial Glycaemia,” Diabetologia, Vol. 22, pp. 450-455 (1982)). This sequence of changes in the blood glucose level is experienced by the consumer as an initial “sugar high,” (i.e., excess levels of glucose or sugar) followed by a “sugar crash” (i.e., depletion of glucose or sugar).

Additionally, elevated blood glucose rise is typically accompanied by a rise in insulin. Insulin is a secreted hormone that regulates normal blood glucose by simulating lipogenesis (production of fat) and inhibiting lipolysis. Excessive blood glucose levels trigger a high insulin response. A higher release of insulin will typically result in the conversion of blood glucose to fat, thereby increasing energy storage by way of fat accumulation.

Certain ingredients, for example catechins and caffeine, have been proposed for the purpose of increasing energy and enhancing energy utilization. However, products containing one or more of these ingredients tend to be highly sugared, wherein the sugar is intended to optimize the energy benefit. Again, such products can contribute to the foregoing problems associated with excess blood glucose levels, rapid depletion thereof, initiation of an insulin response, and ultimate storage of glucose as fat.

The present inventors have surprisingly discovered compositions which overcome the problems associated with the foregoing by mediating and maintaining the blood glucose level such that energy is provided, while avoiding the excessively high levels of blood glucose which could trigger an exaggerated insulin response. These compositions exhibit a reduced postprandial rise in blood glucose (described as having a low Glycemic Index, as defined herein). Surprisingly, these low Glycemic Index compositions have been found to enhance the perceived positive mood and energy in the consumer, without rapid depletions of blood glucose (i.e., mediation of blood glucose) while reducing the insulin response. The compositions of the present invention maintain a desirable blood glucose level for an extended period of time after consumption. These and other benefits of the present invention are described herein.

### SUMMARY OF THE INVENTION

The present invention relates to compositions useful in the field of foods and beverages. In particular, the present invention relates to those compositions which reduce the postprandial rise in blood glucose (described as low Glycemic Index) that synergistically act to provide enhanced metabolism in the mammalian system and inhibit the storage of systemic fat. As an additional benefit, these low Glycemic Index compositions have surprisingly been found to enhance the perceived positive mood and energy in the consumer, without rapid depletions of blood glucose (i.e., mediation of blood glucose) while reducing the insulin response. Such mood and energy enhancements are significantly enhanced relative to compositions containing only green tea, or those which exhibit a high Glycemic Index. In particular, the present invention relates to compositions comprising:

a) one or more flavanols;

b) one or more bracers; and

c) vitamin B;

wherein the composition exhibits a Glycemic Index of about 55 or less.

It has been discovered that this unique combination of ingredients, which provide the defined, low Glycemic Index, work synergistically together to enhance perception of energy and/or improve physiological energy via metabolism enhancement over a long duration of time, all without resulting in sudden peaks of glucose in the mammalian system. Thus, the present compositions effectively modulate glucose in the system, thereby providing energy to the system without resulting in the storage of systemic fat.

### DETAILED DESCRIPTION OF THE INVENTION

The present invention is directed to compositions that are useful, for example, as food and /or beverage compositions. The present invention is further directed to kits comprising such compositions and methods of using such compositions.

Publications and patents are referred to throughout this disclosure. All references cited herein are hereby incorporated by reference.

All percentages and ratios are calculated by weight unless otherwise indicated. All percentages and ratios are calculated based on the total composition unless otherwise indicated.

All component or composition levels are in reference to the active level of that component or composition, and are exclusive of impurities, for example, residual solvents or by-products, which may be present in commercially available sources.

Referred to herein are trade names for components including, but not limited to, certain carbohydrates, flavors, and other components. The inventors herein do not intend to be limited by materials under a certain trade name. Equivalent materials (e.g., those obtained from a different source under a different name or catalog number) to those referenced by trade name may be substituted and utilized in the compositions, kits, and methods herein.

In the description of the invention various embodiments and/or individual features are disclosed. As will be apparent to the ordinarily skilled practitioner, all combinations of such embodiments and features are possible and can result in preferred executions of the present invention.

The compositions, kits, and methods herein may comprise, consist essentially of, or consist of any of the elements as described herein.

As used herein, wherein the term “composition” or the like it utilized, without specific reference to a beverage composition, concentrate, or essentially dry composition, such term is meant to refer to all of the beverage compositions, concentrates, or essentially dry compositions herein.

### Compositions of the Present Invention

The compositions of the present invention modulate glucose metabolism in the mammalian system, providing controlled glucose release and enhanced utilization of energy rather than storage of metabolic fuels as fat. As an additional benefit, these low Glycemic Index compositions have surprisingly been found to enhance the perceived positive mood and energy in the consumer, without rapid depletions of blood glucose (i.e., mediation of blood glucose) while reducing the insulin response. Such mood and energy enhancements are significantly enhanced relative to compositions containing only green tea, or those which exhibit a high Glycemic Index (e.g., greater than about 55).

The present inventors have surprisingly discovered that the present compositions, which comprise a mixture of one or more flavanols, caffeine, vitamin B, and exhibit a low Glycemic Index, synergistically interact to provide such enhanced glucose modulation. This glucose modulation is thereby translated into the perception of energy, as well as the provision of energy over an extended period of time in the system. In particularly preferred embodiments of the present invention, a complex carbohydrate or soluble fiber is included to further enhance this benefit. Additionally, unlike previous disclosures, it is preferred to minimize or exclude certain high glycemic sugars, such as glucose and sucrose, while capitalizing on low glycemic sugars such as fructose. (However, the present inventors do not exclude the use of such high glycemic sugars except where explicitly stated herein.)

As stated, the present inventive compositions comprise:

a) one or more flavanols;

b) one or more bracers;

c) vitamin B;

wherein the composition exhibits a Glycemic Index of about 55 or less. The Glycemic Index exhibited by the compositions of present invention is a critical element of the present invention, such that glucose peaks are avoided upon ingestion of the composition by the mammalian system. As will be discussed further, the Glycemic Index of a given composition may be controlled via a variety of mechanisms such as, for example, excluding or minimizing the presence of certain high glycemic sugars such as glucose and sucrose. Measurement of Glycemic Index is well-known in the art; the analytical methods which follow will further describe such measurement.

As stated the key ingredients utilized in the present invention, i.e., the flavanol, caffeine, and vitamin B, have been found to synergistically interact together to provide the low glycemic, energy production benefits described herein. The ingredients utilized, as well as preferred ingredients and amounts thereof, are described as follows.

Flavanol

The present compositions comprise one or more flavanols. Without intending to be limited by theory, the present inventors have discovered that the flavanol component interacts synergistically with the other require element of the present composition to induce a glycemic response in a controlled matter to stabilize blood sugars, thus providing energy to the user without the need for certain high glycemic sugars such as sucrose and glucose. Accordingly, one or more flavanols will contribute to the onset, and particularly maintenance of energy wherein the composition is ingested.

Flavanols are natural substances present in a variety of plants (e.g., fruits, vegetables, and flowers). The flavanols which may be utilized in the present invention can be extracted from, for example, fruit, vegetables, green tea or other natural sources by any suitable method well known to those skilled in the art. For example, extraction with ethyl acetate or chlorinated organic solvents is a common method to isolate flavanols from green tea. Flavanols may be extracted from either a single plant or mixtures of plants. Many fruits, vegetables, and flowers contain flavanols but to a lesser degree relative to green tea. Non-limiting examples of the most common flavanols which are extracted from tea plants and other members of the Catechu gambir family (Uncaria family) include, for example, catechins, which include catechin, epicatechin, gallocatechin, epigallocatechin, epicatechin gallate, and epigallocatechin gallate. These catechins are a preferred set of flavanols for use in the present invention.

The flavanols utilized in all compositions of the present invention can be present as a component of a tea extract. The tea extract can be obtained from the extraction of unfermented teas, fermented teas, partially fermented teas, and mixtures thereof. Preferably, the tea extracts are obtained from the extraction of unfermented and partially fermented teas. The most preferred tea extracts are green tea. Both hot and cold extracts can be used in the present invention. Suitable methods for obtaining tea extracts are well known. See e.g., Ekanayake, U.S. Pat. No. 5,879,733, issued Mar. 9, 1999; Tsai, U.S. Pat. No. 4,935,256, issued June, 1990; Lunder, U.S. Pat. No. 4,680,193, issued July, 1987; and Creswick, U.S. Patent No. 4,668,525, issued May 26, 1987. The preferred source of flavanols in the compositions of the present invention is green tea.

Alternatively, these same flavanols may be prepared by synthetic or other appropriate chemical methods and incorporated into the present compositions. Flavanols, including catechin, epicatechin, and their derivatives are commercially available.

The amount of flavanols in the beverage compositions of the present invention can vary. However, wherein one or more flavanols are utilized, preferably from about 0.001% to about 5%, more preferably from about 0.001% to about 2%, even more preferably from about 0.01% to about 1%, and most preferably from about 0.01% to about 0.05% of total flavanols is utilized, by weight of the composition. Alternatively or additionally, the present compositions comprise from about 1 milligram to about 200 milligrams of total flavanols per every 240 milliliters of a liquid composition. More preferably, the compositions comprise from about 10 milligrams to about 150 milligrams of total flavanol per every 240 milliliters of a liquid composition. Most preferably, the compositions comprise from about 20 milligrams to about 120 milligrams of total flavanol per every 240 milliliters of a liquid composition.

In all of the embodiments of the present invention, the total amount of flavanols includes any added flavanol as well as any flavanol inherently present in any other component of the present invention (e.g., green tea).

Bracer

The present compositions comprise one or more bracers. Without intending to be limited by theory, the present inventors have discovered that inclusion of one or more bracers aids in mediating the glycemic response associated with ingestion of the present compositions, thus providing further maintenance of energy to the user. It is believed that this occurs through an interaction of the bracer with the flavanol, thereby modulating the release of energy in the system, which ultimately provides a perceived energy state in the user. In addition, it is believed that the bracer is interacting synergistically with the flavanol and vitamin B of the present invention to mediate a glucose response, often without triggering the insulin response.

As is commonly known in the art, bracers can be obtained by extraction from a natural source or can be synthetically produced. Non-limiting examples of bracers include methylxanthines, e.g., caffeine, theobromine, and theophylline. Additionally, numerous other xanthine derivatives have been isolated or synthesized, which may be utilized as a bracer in the compositions herein. See e.g. Bruns, Biochemical Pharmacology, Vol. 30, pp. 325-333 (1981) which describes, inter alia, xanthine, 9-methyl xanthine, 7-methyl xanthine, 3-methyl xanthine, 3,7-dimethyl xanthine, 8-chloromethyl-3,7-dimethyl xanthine, 8-hydroxymethyl-3,7-dimethyl xanthine, 3,7-diethyl xanthine, 3,7-bis-(2-hydroxyethyl) xanthine, 3-propyl-7-(dimethylaminoethyl) xanthine, 1-methyl xanthine, 1,9-dimethyl xanthine, 1-methyl-8-methylthio xanthine, 8-phenyl-1-methyl xanthine, 1,7-dimethyl xanthine, 1,7-dimethyl-8-oxo xanthine, 1,3-dimethyl xanthine, 1,3,9-trimethyl xanthine, 8-fluoro theophylline, 8-chloro theophylline, 8-bromo theophylline, 8-thio theophylline, 8-methylthio theophylline, 8-ethylthio theophylline, 8-nitro theophylline, 8-methylamino theophylline, 8-dimethylamino theophylline, 8-methyl theophylline, 8-ethyl theophylline, 8-propyl theophylline, 8-cyclopropyl theophylline, theophylline-8-propionate (ethyl ester), 8-benzyl theophylline, 8-cyclopentyl theophylline, 8-cyclohexyl theophylline, 8-(3-indolyl) theophylline, 8-phenyl theophylline, 9-methyl-8-phenyl theophylline, 8-(p-chlorophenyl) theophylline, 8-(p-bromophenyl) theophylline, 8-(p-methoxyphenyl) theophylline, 8-(p-nitrophenyl) theophylline, 8-(p-dimethylaminophenyl) theophylline, 8-(p-methylphenyl) theophylline, 8-(3,4-dichlorophenyl) theophylline, 8-(m-nitrophenyl) theophylline, 8-(o-nitrophenyl) theophylline, 8-(o-carboxyphenyl) theophylline, 8-(1-naphthyl) theophylline, 8-(2,6-dimethyl-4-hydroxyphenyl) theophylline, 7-methoxy-8-phenyl theophylline, 1,3,7-trimethyl xanthine, S-chloro caffeine, S-oxo caffeine, S-methoxy caffeine, S-methylamino caffeine, 8-diethylamino caffeine, 8-ethyl caffeine, 7-ethyl theophylline, 7-(2-chloroethyl) theophylline, 7-(2-hydroxyethyl) theophylline, 7-(carboxymethyl) theophylline, 7-(carboxymethyl) theophylline (ethyl ester), 7-(2-hydroxypropyl) theophylline, 7-(2,3-dihydroxypropyl) theophylline, 7-β-D-ribofuranosyl theophylline, 7-(glycero-pent-2-enopyranosyl) theophylline, 7-phenyl theophylline, 7,8-diphenyl theophylline, 1-methyl-3,7-diethyl xanthine, 1-methyl-3-isobutyl xanthine, 1-ethyl-3,7-dimethyl xanthine, 1,3-diethyl xanthine, 1,3,7-triethyl xanthine, 1-ethyl-3-propyl-7-butyl-8-methyl xanthine, 1,3-dipropyl xanthine, 1,3-diallyl xanthine, 1-butyl-3,7-dimethyl xanthine, 1-hexyl-3,7-dimethyl xanthine, and 1-(5-oxohexyl)-3,7-dimethyl xanthine.

Additionally, one or more of these bracers are present in, for example, coffee, tea, kola nut, cacao pod, mate', yaupon, guarana paste, and yoco. Natural plant extracts, particularly green tea, are the preferred sources of bracers.

The most preferred bracer is caffeine. Caffeine may be obtained from the aforementioned plants or, alternatively, may be synthetically prepared. Preferred botanical sources of caffeine which may be utilized as a complete or partial source of caffeine include green tea, guarana, mate', black tea, cola nuts, cocoa, and coffee. As used herein, green tea, guarana, coffee, and mate'are the most preferred botanical sources of caffeine, most preferably green tea, guarana, and coffee. Mate' may have the additional benefit of an appetite suppressing effect and may be included for this purpose as well. The total amount of caffeine, in any embodiment of the present invention, includes the amount of caffeine naturally present in the tea extract, flavoring agent, botanical and any other components, as well as any added caffeine.

Any bracer utilized herein is preferably present in physiologically relevant amounts, which means that the sources used in the practice of this invention provide a safe and effective quantity to achieve the desired mental alertness.

Wherein a bracer is utilized in the present beverage compositions, such compositions will preferably comprise from about 0.0005% to about 1%, more preferably from about 0.003% to about 0.5%, still more preferably from about 0.003% to about 0.2%, even more preferably from about 0.005% to about 0.05%, and most preferably from about 0.005% to about 0.02% of a bracer, by weight of the composition. Of course, as the skilled artisan will comprehend, the actual amount of bracer added will depend the desired biological effect. Alternatively or additionally, the present compositions preferably comprise from about 1 milligram to about 200 milligrams of total bracer, per every 240 milliliters of liquid composition. More preferably, the present compositions comprise from about 10 milligrams to about 100 milligrams of total bracer, per every 240 milliliters of the liquid composition. Most preferably, the present compositions comprise from about 20 milligrams to about 80 milligrams of total bracer, per every 240 milliliters of the liquid composition.

In all of the present compositions, the total amount of bracer includes any added bracer as well as any bracer inherently present in any other component of the present invention (e.g. green tea).

Vitamin B

The compositions herein further comprise vitamin B. Without intending to be limited by theory, it is believed that the vitamin B interacts with the flavanol and the bracer to mediate and maintain a blood glucose response, without the need for high glycemic ingredients such as sucrose and glucose.

As used herein, wherein the term “vitamin B” is used, it is meant to include one or more of the variety of known B vitamins. Vitamin B is well-known in the art. The B vitamins include one or more of thiamin (also commonly referred to as “vitamin B₁”), riboflavin (also commonly referred to as “vitamin B₂”), niacin (also commonly referred to as “vitamin B₃”), pantothenic acid (also commonly referred to as “vitamin B₅”), pyridoxine (also commonly referred to as “vitamin B₆”), biotin, folic acid (also commonly referred to as folate), and the cobalamins (also commonly referred to as “vitamin B₁₂”). Among these, inclusion of vitamin B₁, vitamin B₆, and/or B₁₂ are particularly preferred. It is most preferred to use vitamin B₁, and/or vitamin B₆.

As used herein: the USRDI for thiamin is 1.5 milligrams; the USRDI for riboflavin is 1.7 milligrams; the USRDI for niacin is 20 milligrams; the USRDI for pyridoxine is 3 milligrams; the USRDI for the cobalamins is 6 micrograms; the USRDI for folic acid is 0.4 milligrams; the USRDI for pantothenic acid is 10 milligrams; and the USRDI for biotin is 0.3 milligrams. Wherein a B vitamin is present in the compositions herein, the composition preferably comprises at least about 1%, still preferably at least about 5%, more preferably from about 5% to about 100%, even more preferably from about 5% to about 50%, and most preferably from about 10% to about 30% of the USRDI of each B vitamin present in the composition, per every 240 milliliters of the composition.

Accordingly, the compositions preferably comprise at least about 0.03 milligrams, preferably at least about 0.15 milligrams, more preferably from about 0.15 milligrams to about 3 milligrams, even more preferably from about 0.15 milligrams to about 1.5 milligrams, and most preferably from about 0.3 milligrams to about 0.9 milligrams of vitamin B₆, per every 240 milliliters of the liquid composition.

The ordinarily skilled artisan will understand that the quantity of B vitamin to be added is dependent on processing conditions and the amount of B vitamin delivery desired after storage (dependent on, for example, time, temperature, and type of packaging material utilized).

Low Glycemic

As stated, it is critical that the compositions herein exhibit a Glycemic Index of about 55 or less. Preferably, the compositions exhibit a Glycemic Index of about 45 or less. Measurement of Glycemic Index is well-known in the art; the analytical methods which follow will further describe such measurement.

The Glycemic Index may be controlled via a variety of mechanisms such as, for example, excluding or minimizing the presence of certain high glycemic sugars such as glucose and sucrose. For example, as defined, glucose itself has a Glycemic Index of 100. Sucrose and maltose are highly or moderately glycemic, exhibiting a Glycemic Index of 65 and 105, respectively. See, e.g., Brand-Miller et al., The Glucose Revolution, Marlowe & Co., ISBN 1569246602 (1999).

Accordingly, the present compositions are preferably maintained at a Glycemic Index of about 55 or less by limiting the presence and/or amount of moderate of high glycemic sugars. In a preferred embodiment of the present invention, therefore, the compositions comprise less than about 2% of total free sweetener selected from the group consisting of glucose, sucrose, maltose, and mixtures thereof. The sweeteners are referred to as “free” sweeteners, as this is not meant to include polymers, which may have utility as optional elements (e.g., soluble fibers). Even more preferably, the compositions comprise less than about 1% of total free sweetener selected from the group consisting of glucose, sucrose, maltose, and mixtures thereof. Most preferably, the compositions comprise less than about 0.1% of total free sweetener selected from the group consisting of glucose, sucrose, maltose, and mixtures thereof.

Additionally, wherein a sweetening effect is desired, the sweetener is most preferably fructose since it is a low glycemic sugar. Fructose can be obtained or provided by, for example, liquid fructose (for example, KRYSTAR liquid fructose, containing at least 99.5% fructose, commercially available from Staley Manufacturing Co., Decatur, Ill.), crystalline fructose (for example, KRYSTAR 300 crystalline fructose containing at least 99.5% fructose, also commercially available from Staley), or any mixture thereof. High fructose corn syrup (HFCS) may also be used and is commercially available as HFCS-42, HFCS-55 and HFCS-90, which comprise 42%, 55% and 90%, respectively, by weight of the sugar solids therein, fructose. Wherein HFCS is used, as with all compositions herein, care should of course be utilized such that the final compositions do not exhibit a Glycemic Index exceeding about 55. For example, wherein HFCS is used, it will often be preferred to include other sweetener sources such that the level of HFCS present is appropriately managed. Additionally or alternatively, fructose may optionally be provided through use of other sources, for example fruit juices or botanicals. For example, as discussed below with respect to fruit juices, apple and/or pear juices are particularly preferred due to their low Glycemic Indices. Also, agave, which may be provided as for example a syrup (concentrated juice), nectar, juice, or the like, is also particularly preferred and contains significant levels of fructose. For example, agave syrup is commercially available from Industrializadora Integral del Agave, Mexico as (for example) NATUREL TE-350, NATUREL Agave Flavor, NATUREL Agave Sweet, NATUREL Agave, NATUREL CL-50, and NATUREL F-97.

Preferably, wherein fructose is included, the compositions comprise from about 0.1% to about 10% fructose, by weight of the composition, provided the Glycemic Index of 55 or less is maintained. More preferably, wherein fructose is included, the compositions comprise from about 0.1% to about 7% fructose, by weight of the composition, provided the Glycemic Index of 55 or less is maintained. Most preferably, wherein fructose is included, the compositions comprise from about 1% to about 6% fructose, by weight of the composition, provided the Glycemic Index of 55 or less is maintained.

Other naturally occurring sweeteners or their purified extracts, such as glycyrrhizin, stevioside, the protein sweetener thaumatin, the juice of Luo Han Guo (containing the sweet mogrosides) disclosed in, for example, Fischer et al., U.S. Pat. No. 5,433,965, issued Jul. 18, 1995, and the like can also be used in the beverages of the present invention.

Effective levels of non-caloric sweeteners may optionally be used in the compositions of the present invention to further sweeten such compositions. Non-limiting examples of non-caloric sweeteners include sucralose, neotame, aspartame, saccharine, cyclamates, acesulfame K, L-aspartyl-L-phenylalanine lower alkyl ester sweeteners, L-aspartyl-D-alanine amides such as, for example, those disclosed in Brennan et al., U.S. Pat. No. 4,411,925, issued 1983, L-aspartyl-D-serine amides such as, for example, those disclosed in Brennan et al., U.S. Pat. No. 4,399,163, issued 1983, L-aspartyl-hydroxymethyl alkane amide sweeteners such as, for example, those disclosed in Brand, U.S. Pat. No. 4,338,346, issued 1982, L-aspartyl-1-hydroxyethylalkane amide sweeteners such as, for example, those disclosed in Rizzi, U.S. Pat. No. 4,423,029, issued 1983, glycyrrhizins, and synthetic alkoxy aromatics. Sucralose, aspartame and acesulfame-K, particularly aspartame and sucralose are the most preferred non-caloric sweeteners utilized herein, and may be utilized alone or in various combinations.

Complex Carbohydrates and Soluble Fibers

In a preferred, optional embodiment of the present invention, one or more members selected from complex carbohydrates, soluble fibers, and mixtures thereof are included in the present compositions. The inventors herein have found that inclusion of one or more complex carbohydrates and/or soluble fibers works efficiently in conjunction with the foregoing ingredients to decrease blood sugar and insulin response.

Complex carbohydrates are well-known and include oligosaccharides, polysaccharides, and/or carbohydrate derivatives, preferably oligosaccharides and/or polysaccharides. As used herein, the term “oligosaccharide” means a digestible linear molecule having from 3 to 9 monosaccharide units, wherein the units are covalently connected via glycosidic bonds. As used herein, the term “polysaccharide” means a digestible (i.e., capable of metabolism by the human body) macromolecule having greater than 9 monosaccharide units, wherein the units are covalently connected via glycosidic bonds. The polysaccharides may be linear chains or branched. Preferably, the polysaccharide has from 9 to about 20 monosaccharide units. Carbohydrate derivatives, such as a polyhydric alcohol (e.g., glycerol), may also be utilized as a complex carbohydrate herein. As used herein, the term “digestible” means capable of metabolism by enzymes produced by the human body. Examples of polysaccharides not within the definitions herein include resistant starches (e.g., raw corn starches) and retrograded amyloses (e.g., high amylose corn starches) since such polysaccharides are known to be non-digestible by the human body.

Non-limiting examples of preferred complex carbohydrates include raffinoses, stachyoses, maltotrioses, maltotetraoses, glycogens, amyloses, amylopectins, polydextroses, and maltodextrins. The most preferred complex carbohydrates are maltodextrins.

Maltodextrins are a form of complex carbohydrate molecule which is several glucose units in length. Without intending to be limited by theory, since maltodextrins are hydrolyzed into glucose in the digestive tract, they may be utilized as an extended source of glucose. Maltodextrins may be spray-dried carbohydrate ingredients made by controlled hydrolysis of corn starch. As is commonly known in the art, the dextrose equivalence (“DE”) of maltodextrins provides a good index of the degree of starch polymer hydrolysis. Preferred maltodextrins are those with a DE about 22 or less. Preferred maltodextrins for use herein are those with a DE of from about 15 to about 20, more preferably from about 16 to about 20.

One or more soluble fibers may also optionally be included in the compositions of the present invention for the foregoing purposes. Soluble dietary fibers are a form of carbohydrates which cannot be metabolized by the enzyme system produced by the human body and which pass through the small intestine without being hydrolyzed (and, thus, are not included within the definition of complex carbohydrate herein). Without intending to be limited by theory, since soluble dietary fibers swell in the stomach, they slow down gastric emptying thus prolonging the retention of nutrients in the intestine which results in a feeling of satiation.

Soluble fibers which can be used singularly or in combination in all embodiments of the present invention include but are not limited to pectins, psyllium, guar gum, xanthan gum, alginates, gum arabic, fructo-oligosaccharides, inulin, agar, and carrageenan. Preferred among these soluble fibers are at least one of guar gum, xanthan, and carrageenan, most preferably at least one of guar gum and xanthan. These soluble fibers may also serve as stabilizing agents in the various embodiments of this invention.

Particularly preferred soluble fibers for use herein are glucose polymers, preferably those which have branched chains. Preferred among these soluble fibers is one marketed under the trade name FIBERSOL-2 commercially available from Matsutani Chemical Industry Co., Itami City, Hyogo, Japan.

Pectin and fructo-oligosaccharides are also preferred soluble fibers herein. Even more preferably, pectin and fructo-oligosaccharides are used in combination. The preferred ratio of pectin to fructo-oligosaccharide is from about 3:1 to about 1:3, by weight of the composition. The preferred pectins have a degree of esterification higher than about 65%.

The preferred fructo-oligosaccharides are a mixture of fructo-oligosaccharides composed of a chain of fructose molecules linked to a molecule of sucrose. Most preferably, they have a nystose to kestose to fructosyl-nystose ratio of about 40:50:10, by weight of the composition. Preferred fructo-oligosaccharides may be obtained by enzymatic action of fructosyltransferase on sucrose such as those which are, for example, commercially available from Beghin-Meiji Industries, Neuilly-sur-Seine, France.

Preferred pectins are obtained by hot acidic extraction from citrus peels and may be obtained, for example, from Danisco Co., Braband, Denmark.

Wherein a complex carbohydrate and/or soluble fiber is utilized, the compositions of the present invention comprise from about 0.001% to about 15%, preferably from about 0.1% to about 5%, more preferably from about 0. 1% to about 3%, and most preferably from about 0.2% to about 3% of total complex carbohydrate and soluble fiber, by weight of the composition. The total amount of soluble dietary fiber includes any added soluble dietary fiber as well as any soluble dietary fiber inherently present in any other component of the present invention.

### Other Optional Components of the Present Compositions

As stated, the compositions of the present invention may be utilized as beverage compositions. Consistent with this use, the compositions of the present invention may comprise other optional components to enhance, for example, their performance in providing a desirable nutritional profile, and/or providing enhanced organoleptic properties. For example, one or more non-caloric sweeteners, further nutrients, emulsions, thickeners, flavoring agents, coloring agents, preservatives, acidulants, water, carbonation components, and/or the like may be included in the compositions herein. Such optional components may be dispersed, solubilized, or otherwise mixed into the present compositions. These components may be added to the compositions herein, preferably if they do not result in a composition having a Glycemic Index greater than 55. Non-limiting examples of optional components suitable for use herein are given below.

Further Nutrients

As previously stated, the present compositions comprise vitamin B. The compositions herein may optionally, but preferably, be fortified further with one or more other nutrients, especially one or more vitamins and/or minerals.

Unless otherwise specified herein, wherein a given vitamin is present in the composition, the composition comprises at least about 1%, preferably at least about 2%, more preferably from about 2% to about 200%, even more preferably from about 5% to about 150%, and most preferably from about 10% to about 120% of the USRDI of such vitamin. The United States Recommended Daily Intake (USRDI) for vitamins and minerals is defined and set forth in the Recommended Daily Dietary Allowance-Food and Nutrition Board, National Academy of Sciences-National Research Council.

Non-limiting examples of vitamins other than the previously mentioned vitamin B include vitamin A, vitamin C, vitamin D, and vitamin E. Preferably, wherein a further vitamin is utilized the vitamin is selected from vitamin A, vitamin C, vitamin E, and vitamin D. Preferably, at least one vitamin is selected from vitamin A, vitamin C, and vitamin E.

As used herein, “vitamin A” is inclusive of one or more nutritionally active unsaturated hydrocarbons, including the retinoids (a class of compounds including retinol and its chemical derivatives having four isoprenoid units) and the carotenoids.

Common retinoids include retinol, retinal, retinoic acid, retinyl palmitate, and retinyl acetate.

In a preferred embodiment herein, the vitamin A is a carotenoid. Common carotenoids include beta-carotene, alpha-carotene, beta-apo-8′-carotenal, cryptoxanthin, canthaxanthin, astacene, and lycopene. Among these, beta-carotene is the most preferred for use herein.

The vitamin A may be in any form, for example, an oil, beadlets, or encapsulated. See e.g., Cox et al, U.S. Pat. No. 6,007,856, assigned to The Procter & Gamble Co., issued Dec. 28, 1999. Vitamin A is often available as an oil dispersion, i.e., small particles suspended in oil.

As used herein, the USRDI for vitamin A is 5000 International Units (IU). Wherein vitamin A is present in the compositions herein, the composition typically comprises, per reference serving of the composition, at least about 1%, preferably at least about 5%, more preferably from about 10% to about 100%, even more preferably from about 10% to about 50%, and most preferably from about 10% to about 30% of the USRDI of such vitamin. The ordinarily skilled artisan will understand that the quantity of vitamin A to be added is dependent on processing conditions and the amount of vitamin A delivery desired after storage (dependent on, for example, time, temperature, and type of packaging material utilized).

As used herein, “vitamin C” is inclusive of one or more of L-ascorbic acid (also referred to herein as ascorbic acid), as well as their bioequivalent forms including salts and esters thereof. For example, the sodium salt of ascorbic acid is considered vitamin C herein. Additionally, there are many widely known esters of vitamin C, including ascorbyl acetate. Fatty acid esters of vitamin C are lipid soluble and can provide an antioxidative effect.

The vitamin C utilized may be in any form, for example, free or in encapsulated form. It is highly preferred herein to utilize free vitamin C, for example, as ascorbic acid.

As used herein, the USRDI of vitamin C is about 60 milligrams. Wherein vitamin C is present in the compositions herein, the compositions typically comprise at least about 6 milligrams per reference serving of the composition, more preferably at least about 12 milligrams, still more preferably at least about 30 milligrams, even more preferably from about 40 milligrams to about 200 milligrams, and most preferably from about 48 to about 170 milligrams of vitamin C, per reference serving of the composition. The ordinarily skilled artisan will understand that the quantity of vitamin C to be added is dependent on processing conditions and the amount of vitamin C delivery desired after storage. Thus, it is not uncommon to utilize twice the desired amount (i.e., the labeled amount) of vitamin C during manufacture in the product.

As used herein, “vitamin E” is inclusive of one or more tocols or tocotrienols which exhibit vitamin activity similar to that of alpha-tocopherol (which, as used herein, is considered a tocol) as well as their bioequivalent forms including salts and esters thereof. Vitamin E is typically found in oils including, for example, sunflower, peanut, soybean, cottonseed, corn, olive, and palm oils.

Non-limiting examples of vitamin E include alpha-tocopherol, beta-tocopherol, gamma-tocopherol, and delta-tocopherol, as well as esters thereof (e.g., alpha-tocopherol acetate). Alpha-tocopherol and particularly alpha-tocopherol acetate are highly preferred for use as vitamin E herein.

The vitamin E utilized may be in any form, for example, free or in encapsulated form.

As used herein, the USRDI for vitamin E is 30 International Units (IU). Wherein vitamin E is present in the compositions herein, the composition typically comprises at least about 1%, preferably at least about 2%, more preferably from about 5% to about 100%, even more preferably from about 5% to about 50%, and most preferably from about 15% to about 35% of the USRDI of such vitamin, per reference serving of the composition. Wherein vitamin E is present in the compositions herein, it is especially preferred to include from about 20% to about 25% of the USRDI of vitamin E, per reference serving of the composition. The ordinarily skilled artisan will understand that the quantity of vitamin E to be added is dependent on processing conditions and the amount of vitamin E delivery desired after storage.

Wherein a given additional mineral (i.e., one additional to the calcium and magnesium) is present in the composition, the composition typically comprises at least about 1%, preferably at least about 2%, more preferably from about 5% to about 100%, even more preferably from about 5% to about 40%, and most preferably from about 5% to about 30% of the USRDI of such mineral.

Minerals are well-known in the art. Non-limiting examples of such minerals include calcium, magnesium, zinc, iron, selenium, iodine, and fluoride. Preferably, wherein an additional mineral is utilized, the mineral is selected from zinc and iron. Minerals may be, for example, salts, chelated, complexed, solubilized, or in colloidal form.

Calcium is a particularly preferred mineral for use in the present invention. Preferred sources of calcium include, for example, amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium titrate, calcium gluconate, calcium realate, calcium tantrate, and calcium lactate, and in particular calcium citrate-malate. The form of calcium citrate-malate is described in, e.g., Mehansho et al., U.S. Pat. No. 5,670,344, issued Sep. 23, 1997; Diehl et al., U.S. Pat. No. 5,612,026, issued Mar. 18, 1997; Andon et al., U.S. Pat. No. 5,571,441, issued Nov. 5, 1996; Meyer et al., U.S. Pat. No. 5,474,793, issued Dec. 12, 1995; Andon et al., U.S. Pat. No. 5,468,506, issued Nov. 21, 1995; Burkes et al., U.S. Pat. No. 5,445,837, issued Aug. 29, 1995; Dake et al., U.S. Pat. No. 5,424,082, issued Jun. 13, 1995; Burkes et al., U.S. Pat. No. 5,422,128, issued Jun. 6, 1995; Burkes et al., U.S. Pat. No. 5,401,524, issued Mar. 28, 1995; Zuniga et al, U.S. Pat. No. 5,389,387, issued Feb. 14, 1995; Jacobs, U.S. Pat. No. 5,314,919, issued May 24, 1994; Saltman et al., U.S. Pat. No. 5,232,709, issued Aug. 3, 1993; Camden et al., U.S. Pat. No. 5,225,221, issued Jul. 6, 1993; Fox et al., U.S. Pat. No. 5,215,769, issued Jun. 1, 1993; Fox et al., U.S. Pat. No. 5,186,965, issued Feb. 16, 1993; Saltman et al., U.S. Pat. No. 5,151,274, issued Sep. 29, 1992; Kochanowski, U.S. Pat. No. 5,128,374, issued Jul. 7, 1992; Mehansho et al., U.S. Pat. No. 5,118,513, issued Jun. 2, 1992; Andon et al., U.S. Pat. No. 5,108,761, issued Apr. 28, 1992; Mehansho et al., U.S. Pat. No. 4,994,283, issued Feb. 19, 1991; Nakel et al., U.S. Pat. No. 4,786,510, issued Nov. 22, 1988; and Nakel et al., U.S. Pat. No. 4,737,375, issued Apr. 12, 1988. Preferred compositions of the present invention will comprise from about 0.01% to about 0.5%, more preferably from about 0.03% to about 0.2%, even more preferably from about 0.05% to about 0.15%, and most preferably from about 0.1% to about 0.15% of calcium, by weight of the product.

As used herein, “zinc” is inclusive of any compound containing zinc, including a salt, complex, or other form of zinc, including elemental zinc. Acceptable forms of zinc are well-known in the art. The zinc which can be used in the present invention can be in any of the commonly used forms such as, e.g., zinc lactate, zinc sulfate, zinc chloride, zinc acetate, zinc gluconate, zinc ascorbate, zinc citrate, zinc aspartate, zinc picolinate, amino acid chelated zinc, and zinc oxide. Zinc gluconate and amino acid chelated zinc are particularly preferred. Additionally, it has been found that amino acid chelated zinc is most highly preferred, as this zinc form provides optimized bioavailability of the zinc. Zinc oxide is also particularly preferred.

Amino acid chelates of zinc are well-known in the art, and are described in, for example, Pedersen et al., U.S. Pat. No. 5,516,925, assigned to Albion International, Inc., issued May 14, 1996; Ashmead, U.S. Pat. No. 5,292,729, assigned to Albion International, Inc., issued Mar. 8, 1994; and Ashmead, U.S. Pat. No. 4,830,716, assigned to Albion International, Inc., issued May 16, 1989. These chelates contain one or more natural amino acids selected from alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine and valine or dipeptides, tripeptides or quadrapeptides formed by any combination of these amino acids.

Additionally, encapsulated zinc is also preferred for use herein.

As used herein, the USRDI for zinc is 15 milligrams. Zinc fortified compositions of the present invention typically contain at least about 0.5 milligrams of zinc, more preferably from about 1 milligram to about 7 milligrams, even more preferably from about 1 milligram to about 6 milligrams, and most preferably from about 1 milligram to about 5 milligrams of zinc, all per reference serving of the composition. As used herein, recitations of mass of zinc in any given composition refers to the mass or weight percent of the zinc-containing component (for example, the amino acid chelated zinc component), rather than the mass of elemental zinc which is part of the zinc-containing component. Of course, wherein elemental zinc is utilized as the zinc, the mass or weight percent of zinc in any given composition refers to that of the elemental zinc.

As used herein, “iron” is inclusive of any compound containing iron, including a salt, complex, or other form of iron, including elemental iron. Acceptable forms of iron are well-known in the art.

Non-limiting examples of ferrous iron sources which can be used in the present invention include ferrous sulfate, ferrous fumarate, ferrous succinate, ferrous gluconate, ferrous lactate, ferrous tartrate, ferrous citrate, ferrous amino acid chelates, and ferrous pyrophsophate, as well as mixtures of these ferrous salts. While ferrous iron is typically more bioavailable, certain ferric salts can also provide highly bioavailable sources of iron. Non-limiting examples of ferric iron sources that can be used in the present invention are ferric saccharate, ferric ammonium citrate, ferric citrate, ferric sulfate, ferric chloride, and ferric pyrophosphate, as well as mixtures of these ferric salts. A particularly preferred ferric iron source is ferric pyrophosphate, for example, microencapsulated SUNACTIVE Iron (for example, SUNACTIVE Fe12 Superdispersion (preferred) and SUNACTIVE P80 Powder, commercially available from Taiyo International, Inc., Edina, Minn., U.S.A and Yokkaichi, Mie, Japan. SUNACTIVE Iron is particularly preferred for use herein due to its water-dispersibility, particle size, compatibility, and bioavailability.

Ferrous amino acid chelates particularly suitable as highly bioavailable amino acid chelated irons for use in the present invention are those having a ligand to metal ratio of at least 2:1. For example, suitable ferrous amino acid chelates having a ligand to metal mole ratio of two are those of formula:

Fe(L)₂

where L is an alpha amino acid, dipeptide, tripeptide or quadrapeptide reacting ligand. Thus, L can be any reacting ligand that is a naturally occurring alpha amino acid selected from alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine and valine or dipeptides, tripeptides or quadrapeptides formed by any combination of these amino acids. See e.g., Pedersen et al., U.S. Pat. No. 5,516,925, assigned to Albion International, Inc., issued May 14, 1996; Ashmead, U.S. Pat. No. 5,292,729, assigned to Albion International, Inc., issued Mar. 8, 1994; and Ashmead, U.S. Pat. No. 4,830,716, assigned to Albion International, Inc., issued May 16, 1989. Particularly preferred ferrous amino acid chelates are those where the reacting ligands are glycine, lysine, and leucine. Most preferred is the ferrous amino acid chelate sold under the trade name FERROCHEL having the reacting ligand as glycine. FERROCHEL is commercially available from Albion Laboratories, Salt Lake City, Utah.

In addition to these highly bioavailable ferrous and ferric salts, other sources of bioavailable iron can be included in the compositions of the present invention. Other sources of iron particularly suitable for fortifying compositions herein certain iron-sugar-carboxylate complexes. In these iron-sugar-carboxylate complexes, the carboxylate provides the counterion for the ferrous (preferred) or ferric iron. The overall synthesis of these iron-sugar-carboxylate complexes involves the formation of a calcium-sugar moiety in aqueous media (for example, by reacting calcium hydroxide with a sugar, reacting the iron source (such as ferrous ammonium sulfate) with the calcium-sugar moiety in aqueous media to provide an iron-sugar moiety, and neutralizing the reaction system with a carboxylic acid (the “carboxylate counterion”) to provide the desired iron-sugar-carboxylate complex). Sugars that can be used to prepare the calcium-sugar moiety include any of the ingestible saccharidic materials, and mixtures thereof, such as glucose, sucrose and fructose, mannose, galactose, lactose, maltose, and the like, with sucrose and fructose being the more preferred. The carboxylic acid providing the “carboxylate counterion” can be any ingestible carboxylic acid such as citric acid, malic acid, tartaric acid, lactic acid, succinic acid, and propionic acid, as well as mixtures of these acids.

These iron-sugar-carboxylate complexes can be prepared in the manner described in Nakel et al., U.S. Pat. No. 4,786,510 and 4,786,518, issued Nov. 22, 1988. These materials are referred to as “complexes”, but they may, in fact, exist in solution as complicated, highly hydrated, protected colloids; the term “complex” is used for the purpose of simplicity.

Additionally, encapsulated iron is also preferred for use herein. For example, ferrous sulfate encapsulated in a hydrogenated soybean oil matrix may be used, for example, CAP-SHURE which is commercially available from Bachem Corp., Slate Hill, N.Y. Other solid fats can be used to encapsulate the iron, such as, tristearin, hydrogenated corn oil, cottonseed oil, sunflower oil, tallow, and lard. A particularly preferred encapsulated iron source is microencapsulated SUNACTIVE Iron, commercially available from Taiyo International, Inc., Edina, Minn., U.S.A. SUNACTIVE Iron is particularly preferred for use herein due to its water-dispersibility and bioavailability.

As used herein, the USRDI for iron is 18 milligrams. Iron fortified compositions of the present invention preferably contain at least about 0.5 milligrams of iron, more preferably from about 0.5 to about 10 milligrams of iron, even more preferably from about 2 to about 7 milligrams of iron, and most preferably from about 3 milligrams to about 6 milligrams of iron, all per reference serving of the composition. As used herein, recitations of mass in any given composition refers to the mass of the iron-containing component (for example, the amino acid chelated iron component), rather than the mass or weight percent of the elemental iron which is part of the iron-containing component. Of course, wherein elemental iron is utilized as the “iron”, the mass of iron in any given composition refers to that of the elemental iron.

Other minerals such as, for example, selenium, iodine, and fluorine may optionally be used herein.

Emulsions

Dilute juice beverages of the present invention may optionally, but preferably, comprise from about 0.2% to about 5%, preferably from about 0.5% to about 3%, and most preferably from about 0.8% to about 2%, of a beverage emulsion. This beverage emulsion can be either a cloud emulsion or a flavor emulsion. Emulsions are described in, for example, U.S. Pat. No. 5,616,358, Taylor et al., assigned to The Procter & Gamble Co., issued Apr. 1, 1997, U.S. Pat. No. 5,624,698, Dake et al., assigned to The Procter & Gamble Co., issued Apr. 29, 1997, and Kupper et al., U.S. Pat. 4,705,691, issued Nov. 10, 1987.

Thickeners

One or more thickeners may be optionally added to the present compositions to, for example, provide control of viscosity and/or texture. Various thickeners are well-known in the art. Non-limiting examples of thickeners include cellulose compounds, gum ghatti, modified gum ghatti, xanthan gum, tragacanth gum, guar gum, gellan gum, locust bean gum, pectin, and mixtures thereof. See e.g., Kupper et al., U.S. Pat. No. 4,705,691, issued Nov. 10, 1987. Particularly preferred for use herein include xanthan gum, gellan gum, guar gum, and cellulose compounds (e.g., carboxymethylcellulose, methylcellulose, and hydroxyethylcellulose, hydroxypropylcellulose).

Flavoring Agents

One or more flavoring agents are recommended for the embodiments of the present invention in order to enhance their palatability. Any natural or synthetic flavor agent can be used in the present invention. For example, it is highly preferred to include fruit juice in the present compositions. It is also a preferred embodiment to include one or more botanical and/or fruit flavors may be utilized herein. Thus, the flavor agent can also comprise a blend of various flavors. As used herein, such flavors may be synthetic or natural flavors.

Any of a variety of fruit juices and/or fruit juice concentrates may be incorporated herein including, for example, apple, pear, strawberry, lemon, grapefruit, kiwi, lime, grape, tangerine, orange, cherry, raspberry, cranberry, peach, watermelon, passion fruit, pineapple, mango, cupuacu, guava, cocoa, papaya, and apricot fruit juices, as well as mixtures thereof, may be used. Fruit juices are particularly preferred for use herein, particularly wherein it is desired to include the low glycemic fructose. Apple and/or pear juice are particularly preferred in this respect, most particularly apple juice, as these are found to be especially low glycemic fruit juices.

In a particularly preferred embodiment, the present compositions comprise greater than 0%, more preferably at least about 5%, still more preferably from about 5% to about 60%, even more preferably from about 5% to about 40%, and most preferably from about 5% to about 30% fruit juice, all by weight of the composition.

Fruit flavors may also be used. Particularly preferred fruit flavors are apple, strawberry, lemon, grapefruit, kiwi, lime, grape, tangerine, orange, cherry, raspberry, cranberry, peach, watermelon, and the like, as well as mixtures thereof. Blends of flavors (for example, tangerine-orange) are most preferred. Exotic and lactonic flavors such as, for example, passion fruit, pineapple, mango, cupuacu, guava, cocoa, papaya, and apricot, as well as mixtures thereof, may also be utilized. These fruit flavors can be derived from natural sources such as fruit juices and flavor oils, or may alternatively be synthetically prepared.

Preferred botanical flavors include, for example, agave, tea (preferably black and green tea, most preferably green tea), aloe vera, guarana, ginseng, ginkgo, hawthorn, hibiscus, rose hips, chamomile, peppermint, fennel, ginger, licorice, lotus seed, schizandra, saw palmetto, sarsaparilla, safflower, St. John's Wort, curcuma, cardimom, nutmeg, cassia bark, buchu, cinnamon, jasmine, haw, chrysanthemum, water chestnut, sugar cane, lychee, bamboo shoots, vanilla, coffee, and the like. Preferred among these are agave, ginger, tea, guarana, ginseng, ginko, and coffee. In particular, the combination of tea flavors, preferably green tea or black tea flavors (preferably green tea), optionally together with fruit flavors has an appealing taste. In another preferred embodiment, coffee is included within the present compositions. A combination of green tea and coffee in the present compositions is often preferred. It is also often preferred to include agave, for example as a juice or nectar, as agave is especially low glycemic.

If desired, the flavor in the flavoring agent may be formed into emulsion droplets which are then dispersed in the beverage composition or concentrate. Because these droplets usually have a specific gravity less than that of water and would therefore form a separate phase, weighting agents (which can also act as clouding agents) can be used to keep the emulsion droplets dispersed in the beverage composition or concentrate. Examples of such weighting agents are brominated vegetable oils (BVO) and resin esters, in particular the ester gums. See L. F. Green, Developments in Soft Drinks Technology, Vol. 1, Applied Science Publishers Ltd., pp. 87-93 (1978) for a further description of the use of weighting and clouding agents in liquid beverages. Typically the flavoring agents are conventionally available as concentrates or extracts or in the form of synthetically produced flavoring esters, alcohols, aldehydes, terpenes, sesquiterpenes, and the like.

Coloring Agent

Small amounts of one or more coloring agents may be utilized in the compositions of the present invention. FD&C dyes (e.g., yellow #5, blue #2, red #40) and/or FD&C lakes are preferably used. By adding the lakes to the other powdered ingredients, all the particles, in particular the colored iron compound, are completely and uniformly colored and a uniformly colored beverage mix is attained. Preferred lake dyes which may be used in the present invention are the FDA-approved Lake, such as Lake red #40, yellow #6, blue #1, and the like. Additionally, a mixture of FD&C dyes or a FD&C lake dye in combination with other conventional food and food colorants may be used. Riboflavin and β-carotene may also be used. Additionally, other natural coloring agents may be utilized including, for example, fruit, vegetable, and/or plant extracts such as grape, black currant, aronia, carrot, beetroot, red cabbage, and hibiscus.

The amount of coloring agent used will vary, depending on the agents used and the intensity desired in the finished product. The amount can be readily determined by one skilled in the art. Generally, if utilized, the coloring agent should be present at a level of from about 0.0001% to about 0.5%, preferably from about 0.001% to about 0.1%, and most preferably from about 0.004% to about 0.1%, by weight of the composition.

Preservatives

Preservatives may or may not be needed for use in the present compositions. Techniques such as aseptic and/or clean-fill processing may be utilized to avoid preservatives.

One or more preservatives may, however, optionally be added to the present compositions. Preferred preservatives include, for example, sorbate, benzoate, and polyphosphate preservatives (for example, sodium hexametapolyphosphate).

Preferably, wherein a preservative is utilized herein, one or more sorbate or benzoate preservatives (or mixtures thereof) are utilized. Sorbate and benzoate preservatives suitable for use in the present invention include sorbic acid, benzoic acid, and salts thereof, including (but not limited to) calcium sorbate, sodium sorbate, potassium sorbate, calcium benzoate, sodium benzoate, potassium benzoate, and mixtures thereof. Sorbate preservatives are particularly preferred. Potassium sorbate is particularly preferred for use in the present invention.

Wherein a composition comprises a preservative, the preservative is preferably included at levels from about 0.0005% to about 0.5%, more preferably from about 0.001% to about 0.4% of the preservative, still more preferably from about 0.001% to about 0.1%, even more preferably from about 0.001% to about 0.05%, and most preferably from about 0.003% to about 0.03% of the preservative, by weight of the composition. Wherein the composition comprises a mixture of one or more preservatives, the total concentration of such preservatives is preferably maintained within these ranges.

Acidulants

If desired, the present compositions may optionally comprise one or more acidulants. An amount of an acidulant may be used to maintain the pH of the composition. Compositions of the present invention preferably have a pH of from about 2 to about 7, more preferably from about 2.5 to about 7, and most preferably from about 3.5 to about 4.5. Beverage acidity can be adjusted to and maintained within the requisite range by known and conventional methods, e.g., the use of one or more of the aforementioned acidulants. Typically, acidity within the above recited ranges is a balance between maximum acidity for microbial inhibition and optimum acidity for the desired beverage flavor.

Organic as well as inorganic edible acids may be used to adjust the pH of the beverage, and may be added additional to the acid serving as part of the second component herein. The acids can be present in their undissociated form or, alternatively, as their respective salts, for example, potassium or sodium hydrogen phosphate, potassium or sodium dihydrogen phosphate salts. The preferred acids are edible organic acids which include citric acid, malic acid, fumaric acid, adipic acid, phosphoric acid, gluconic acid, tartaric acid, ascorbic acid, acetic acid, phosphoric acid or mixtures thereof. The most preferred acids are citric and malic acids.

The acidulant can also serve as an antioxidant to stabilize beverage components. Examples of commonly used antioxidant include but are not limited to ascorbic acid, EDTA (ethylenediaminetetraacetic acid), and salts thereof.

Water

Water may be utilized in the present compositions, particularly wherein concentrates and/or ready-to-drink compositions are provided. Ready-to-drink beverage compositions will typically comprise at least about 50% water, more preferably at least about 70% water, by weight of the composition. As used herein, the water of the composition includes all added water and any water present in combination components, for example, fruit juice.

Carbonation Component

Carbon dioxide can be introduced into the beverage composition to achieve carbonation. The carbonated beverage can be placed into a container, such as a bottle or can, and then sealed. Any conventional carbonation methodology may be utilized to make carbonated beverage compositions of this invention. The amount of carbon dioxide introduced into the beverage will depend upon the particular flavor system utilized and the amount of carbonation desired.

### Methods of Making

The present compositions are made according to methods which will be well known by the ordinarily skilled artisan. For convenience, non-limiting examples of methods of making follow.

To illustrate, the compositions of the present invention may be prepared by dissolving, dispersing, or otherwise mixing all components singularly or in suitable combinations together and in water where appropriate, agitating with a mechanical stirrer until all of the ingredients have been solubilized or adequately dispersed. Where appropriate, all separate solutions and dispersed may then be combined. When using tea extracts which typically are pH sensitive, it is important to adjust the desired pH with an acidulant and/or buffer system before adding the tea extracts to the mixture. Wherein a shelf stable composition is desired, the final mixture can optionally, but preferably, be pasteurized or filled aseptically at appropriate process conditions.

In making a beverage composition, a beverage concentrate may optionally be formed first. One method to prepare the concentrate form of the beverage composition would be to start with less than the required volume of water that is used in the preparation of the beverage composition. Another method would be to partially dehydrate the finally prepared beverage compositions to remove only a portion of the water and any other volatile liquids present. Dehydration may be accomplished in accordance with well known procedures, such as evaporation under vacuum. The concentrate can be in the form of a relatively thick liquid. A syrup is typically formed by adding suitable ingredients such as electrolytes or emulsions to the beverage concentrate. The syrup is then mixed with water to form a finished beverage or finished beverage concentrate. The weight ratio of water to syrup is typically from about 1:1 to about 5:1.

Carbon dioxide can be introduced either into the water to be mixed with the beverage concentrate, or into the drinkable beverage composition, to achieve carbonation. The carbonated beverage composition can then be stored in a suitable container and then sealed. Techniques for making and carbonating beverage embodiments of the present invention are described in the following references: L. F. Green (ed.), Developments in Soft Drinks Technology, Vol. 1 (Elsevier, 1978); G. S. Cattell and P. M. Davies, “Preparation and Processing of Fruit Juices, Cordials and Drinks”, Journal of the Society of Dairy Technology; Vol. 38 (1), pp. 21-27, A. H. Varnam and J. P. Sutherland, Beverages-Technology, Chemistry and Microbiology, Chapman Hall, 1994; and A. J. Mitchell (ed.), Formulation and Production of Carbonated Soft Drinks, Blackie and Sons Ltd., 1990.

The essentially dry mixtures of the present invention can be prepared by blending the proper amounts and ratios of all the required dry ingredients together. Alternatively, the finally prepared beverage compositions can be dehydrated to give the essentially dry mixture of the beverage composition. The essentially dry mixture, either as, for example, a powder, granules or tablets, can later be dissolved in a proper amount of water, carbonated or non-carbonated, to make the final drinkable beverage or taken in conjunction with water. Alternatively, dry forms of the present invention may be incorporated in other compositions, including but not limited to cereal bars, breakfast bars, energy bars, and nutritional bars.

Other essentially dry forms include, for example, tablets, capsules, granules, and dry powders. Tablets may contain suitable binders, lubricants, diluents, disintegrating agents, coloring agents, flavoring agents, flow-inducing agents, and melting agents. Suitable carriers and excipients that may be used to formulate dry forms of the present invention are described in, for example, Rober, U.S. Pat. No. 3,903,297, issued Sep. 2, 1975. Techniques and compositions for making dry forms useful in the methods of this invention are described in the following references: H. W. Houghton (ed.), Developments in Soft Drinks Technology, Vol. 3, Chapter 6, (Elsevier, 1984); Modern Pharmaceutics, Chapters 9 and 10 (Banker & Rodes (ed.), 1979); Liberman et al., Pharmaceutical Dosage Forms: Tablets (1981); and Ansel, Introduction to Pharmaceutical Dosage Forms, 2nd Ed., (1976).

### Kits of the Present Invention

The compositions of the present invention, including beverage compositions, may be utilized in kits as described herein. The kits of the present invention comprise one or more compositions of the present invention together with information which informs a user of the kit, by words, pictures, and/or the like, that use of the kit will provide one or more benefits including, but not limited to, perceived energy, physiological energy, low glycemic benefits (for example, creation of energy in the mammalian system without attendant spikes in blood glucose), and combinations thereof. Such direction need not utilize the actual words “perceived”, “physiological”, “glycemic”, or “energy” (for example) but rather use of words, pictures, symbols, and the like conveying the same or similar meaning are contemplated within the scope of this invention.

Perceived energy may be measured by use of the widely-accepted and statistically validated “Profile of Mood States” analytical method. See, McNair et al., “EITS Manual for the Profile of Mood States”, published by the Education and Industrial Testing Service, 1981.

Physiological energy and low glycemic benefits may be obtained to determine using any of a variety of known methods, for example blood glucose measurement. See e.g., Gomes et al., “Anti-hyperglycemic Effect of Black Tea (Camellia sinensis) in Rat”, Journal of Ethnopharmacology, Vol. 45, pp. 223-226 (1995) and Pizziol et al., “Effects of Caffeine on Glucose Tolerance: A Placebo-Contolled Study”, European Journal of Clinical Nutrition, Vol. 52, pp. 846-849 (1998).

### Methods of the Present Invention

The methods of the present invention comprise orally administering (i.e., through ingestion) a composition of the present invention to a mammal, preferably a human, to enhance the perceived energy of such mammal. The compositions of the present invention are preferably ingested by consumers desiring a refreshing energy source, a means to satisfy between-meal hunger, or a means to improve glucose response without the usual peaks in blood glucose. The compositions of this invention may also be ingested as a supplement to normal dietetic requirements for, for example, energy, nutrition, and/or hydration. Frequency of administration is not limited, however, such administration is typically at least once weekly, more preferably at least 3 times weekly, and most preferably at least once daily.

As used herein, the term “orally administering” with respect to the mammal preferably, human) means that the mammal ingests or is directed to ingest (preferably, for the purpose of providing energy and/or mental alertness) one or more compositions of the present invention. Preferably, the composition is a beverage composition, concentrate, or essentially dry composition as has been described herein. Wherein the mammal is directed to ingest one or more of the compositions, such direction may be that which instructs and/or informs the user that use of the composition may and/or will provide energy, energy enhancement, energy maintenance, mental alertness, and/or the like.

For example, such direction may be oral direction (e.g., through oral instruction from, for example, a physician, health professional, sales professional or organization, and/or radio or television media (i.e., advertisement) or written direction (e.g., through written direction from, for example, a physician or other health professional (e.g., scripts), sales professional or organization (e.g., through, for example, marketing brochures, pamphlets, or other instructive paraphernalia), written media (e.g., internet, electronic mail, or other computer-related media), and/or packaging associated with the composition (e.g., a label present on a package containing the composition). As used herein, “written” means through words, pictures, symbols, and/or other visible descriptors. Such direction need not utilize the actual words “energy”, “mental alertness”, “human”, or “mammal” (for example) but rather use of words, pictures, symbols, and the like conveying the same or similar meaning are contemplated within the scope of this invention.

### Analytical Methods

The following analytical methods may be utilized herein, to further define the present invention:

Glycemic Index

The present compositions exhibit a Glycemic Index of about 55 or less, preferably about 45 or less, more preferably about 35 or less, and most preferably from about 18 to about 27. Glycemic Indices of the compositions herein is determined in accordance with the method set forth in Brand-Miller et al., The Glucose Revolution, Marlowe & Co., ISBN 1569246602, pp. 26-27 (1999). For convenience, this method is reiterated below:

1. An amount of a test composition (e.g., a composition according to the present invention) containing 50 grams of carbohydrate is consumed by a human volunteer. Carbohydrate content of test compositions is determined according to well-established methods.

2. Over the next two hours, a blood sample is obtained from the volunteer every 15 minutes during the first hour and thereafter every 30 minutes. The blood sugar level of each blood sample is measured according to standard techniques and recorded.

3. The blood sugar level is plotted on a graph (blood sugar level against time) and the area under the curve is calculated using a computer program.

4. The volunteer's response is divided by the same volunteer's response to 50 grams of pure glucose (the reference food), and multiplied by 100 to give an individual Glycemic Index for the test composition.

5. The volunteer's individual Glycemic Index for the test composition is measured on three separate occasions (three separate days) and averaged to give the average Glycemic Index for that volunteer.

6. In accordance with the present invention, the average Glycemic Indices for 10 volunteers (for a given test composition) are averaged to give the Glycemic Index for that test composition.

Enhancement of Perceived Energy

As used herein, the term “enhancing perceived energy” or the like means to enhance the perception of mental alertness and/or energy in a consumer as described herein. Such enhancement may be measured by any of a variety of methods well-known in the art, however, the preferred method is a method as set forth herein below. This method is referred to herein for simplicity as the “Evaluation Method.” The Evaluation Method is similar to the widely-accepted and statistically validated “Profile of Mood States” analytical method and has been modified to measure the perceptions of interest herein, using a test beverage composition, a control (placebo) beverage composition, and a reference beverage composition. See, McNair et al., “EITS Manual for the Profile of Mood States”, published by the Education and Industrial Testing Service, 1981. A non-limiting example of the Evaluation Method is performed as follows:

The effect of a beverage composition of the present invention on mental alertness is measured using, for example, 60 human subjects (for example, 30 males and 30 females). The subjects report to a testing facility on three occasions, wherein the second occasion occurs 48 hours after the first occasion, and the third occasion occurs 48 hours after the second occasion. The subject should report to the testing facility during “low energy” times of day, i.e., from about 1 PM to about 4 PM during the day.

During these three occasions, each subject will ingest a different beverage composition, such that on completion of the method, each subject has ingested the same three different beverage compositions. Order of ingestion for the three different beverage compositions will be randomized among all subjects, i.e., for any given subject it is not critical which beverage composition is ingested first, second, or third, relative to any other subject.

The beverage compositions tested according to the method herein are the following:

(a) a beverage composition of the present invention (“test composition”);

(b) an aqueous maltodextrin composition having a Glycemic Index of about 100; and

(c) a reference composition, wherein the reference composition is, for example, a green tea beverage containing an amount of sugar and/or carbohydrate sufficient such that the composition has a Glycemic Index greater than about 60.

At the start of any given occasion, the subject completes a perception questionnaire to provide a baseline reading. The perception questionnaire asks the subject whether the word “energetic” describes the manner in which the subject feels at the time of reading the word. Optionally, other words/phrases may be utilized, for example, “lively”, “worn out”, “alert”, “fatigued”, and “sluggish”.

The subject is instructed to choose from 5 descriptors for the word, which are:

1) not at all

2) a little;

3) moderately;

4) quite a bit;

5) extremely.

Answers are recorded by the subject. A test administrator will assign point values to each descriptor. For example, an answer of “not at all” will receive 1 point; “a little” will receive 2 points; “moderately” will receive 3 point; “quite a bit” will receive 4 points; and “extremely” will receive 5 points.

Upon completion of this baseline, during any given occasion, a subject will then ingest one of a:

(a) 330 mL of the test composition over a ten minute period;

(a) 330 mL of the maltodextrin composition over a ten minute period; or

(c) 330 mL of the reference composition over a ten minute period.

After consumption of one of these compositions, a given subject will repeat a new perception questionnaire at various time points. Each new perception questionnaire sets forth the same words and descriptors as have been described above, and the test administrator uses the same point assignment system as previously utilized. The time points are: 15, 30, 45, 60, 90, 120, 150, and 180 minutes after consumption of the composition. Point assignments will be averaged for the 15, 30, 45, 60, 90, 120, and 150 minute time points for each subject, to determine “provision of mental alertness” (the 180 minute time period is not included to discount for any “artificial” feelings of alertness and/or energy related to completion of the test). Point assignments will be averaged for the 90, 120, and 150 minute time points for each subject, to determine “maintenance of mental alertness.”

On the second and third occasions, the above-described steps will be taken, wherein each subject ingests one of the three compositions not ingested on any previous occasion.

After the third occasion, student t-tests will be utilized to compare the mean normalized point averages for “provision of mental alertness” and “maintenance of mental alertness” among the three occasions. The data is normalized to account for baseline variation for each of the subjects. Based on aggregated data for each of the 60 subjects and for a given composition, ninety-five percent (95%) confidence (separately for “provision of mental alertness” and “maintenance of mental alertness”) will be considered significant.

Using this Evaluation Method, the preferred test compositions herein surprisingly provide and/or maintain mental alertness significantly better relative to the maltodextrin composition and /or the reference composition.

### EXAMPLES

The following are non-limiting examples of the present compositions which are prepared utilizing conventional methods. The following examples are provided to illustrate the invention and are not intended to limit the scope thereof in any manner.

### Example 1

A beverage composition is prepared using the following ingredients in the indicated amounts. The composition contains about 30 milligrams of caffeine and about 35 milligrams of (-) epigallocatechin-3-gallate (as well as other flavanols) per every 240 milliters. The calculated Glycemic Index is from about 20 to about 25.

| Ingredient | Weight Percent |
|---|---|
| Apple Juice Concentrate | 0.94 |
| Fructose | 5.6 |
| Erythritol | 3 |
| Green Tea | 0.34 |
| Natural Flavors, including grape, lemon, and | 0.08 |
| vanilla flavors | |
| Citric Acid | 0.24 |
| Sodium Citrate | 0.07 |
| FIBERSOL-2 (Matsutani Chemical Industry Co., | 1.7 |
| Itami City, Hyogo, Japan) | |
| Thiamin hydrochloride (Vitamin B₁) | 0.00014 |
| Vitamin B₆ | 0.00024 |
| Ascorbic Acid | 0.04 |
| Water | Quantum satis |

The beverage composition is prepared by combining the ingredients in a conventional manner and pasteurizing at about 187° F. for about 13 seconds. The beverage is then hot-packed into clean, multi-layer PET bottles.

A consumer ingesting the beverage composition exhibits the perception of enhanced energy and altertness relative to ingesting a high Glycemic Index beverage product containing green tea. Additionally, the insulin response is not initiated upon consumption of the beverage composition of this example.

### Example 2

A carbonated beverage composition having a Glycemic Index from about 20 to about 25 is prepared using the following ingredients in the indicated amounts. The carbonated composition contains about 30 milligrams of caffeine and about 35 milligrams of (-) epigallocatechin-3-gallate (as well as other flavanols) per every 240 milliters.

| Ingredient | Weight Percent |
|---|---|
| Apple Juice Concentrate | 0.94 |
| Fructose | 5.6 |
| Erythritol | 3 |
| Green Tea | 0.45 |
| Natural Flavors, including grape, lemon, and | 0.08 |
| vanilla flavors | |
| Citric Acid | 0.24 |
| Sodium citrate | 0.07 |
| FIBERSOL-2 (Matsutani Chemical Industry Co., | 1.7 |
| Itami City, Hyogo, Japan) | |
| Thiamin hydrochloride (Vitamin B₁) | 0.00014 |
| Vitamin B₆ | 0.00012 |
| Ascorbic Acid | 0.04 |
| Sodium Hexametaphosphate | 0.1 |
| Sodium Benzoate | 0.02 |
| Water | Quantum satis |

The carbonated beverage composition is prepared by combining the ingredients in a conventional manner and pasteurizing at about 187° F. for about 13 seconds. The beverage is then cold-filled into a sanitized carbonator. The beverage composition is carbonated to approximately 2.5 volumes over about 30 minutes. The carbonated beverage composition is filled into bottles which have been cleaned with an iodine solution.

A consumer ingesting the beverage composition exhibits the perception of enhanced energy and altertness relative to ingesting a high Glycemic Index beverage product containing green tea. Additionally, the insulin response is not initiated upon consumption of the beverage composition of this example.

### Example 3

A low Glycemic Index peanut butter-filled cracker bar is prepared having the following ingredients:

| | Crumb Formula | Filling Formula |
|---|---|---|
| Ingredient | grams/100 grams | grams/100 grams |
| Soybean Oil | 9.12 | 15.29 |
| Malt Syrup | 1.24 | |
| Peanut Oil | | 1.80 |
| Green tea extract | 0.34 | |
| Fructose | 3.1 | 8.5 |
| Erythritol | 1.7 | 5 |
| Iodized Salt | | 1.10 |
| Salt - TFC Purex | 0.30 | |
| L-Cysteine HCl Monohydrate | 0.042 | |
| Whole wheat flour | 42.77 | |
| Fiber - insoluble wheat (VITACEL | 3.00 | |
| WF-600/30, J. Rettenmaier, | | |
| Ellwangen/J, Germany) | | |
| Fiber - soluble (FIBERSOL-2, | 3.50 | 12.31 |
| Matsutani Chem. Ind., Itami-city | | |
| Hyogo, Japan) | | |
| Isolated Soy Protein | 6.0 | |
| Sodium Bicarbonate | 0.95 | |
| Calcium Phosphate Monobasic | 0.76 | |
| Sodium Aluminum Phosphate | 0.76 | |
| Ammonium Bicarbonate | 2.40 | |
| Processed De-fatted (20%) Peanut | | 56 |
| Flour | | |
| Vitamin B₁ | 0.0014 | |
| Vitamin B₆ | 0.0024 | |
| Water | 24.01 | |

### Example 4

A low Glycemic Index peanut butter-filled cracker bar is prepared having the following ingredients:

| | Crumb Formula | Filling Formula |
|---|---|---|
| Ingredient | grams/100 grams | grams/100 grams |
| Soybean Oil | 9.12 | 31 |
| Malt Syrup | 1.24 | |
| Fructose | 3.1 | |
| Erythritol | 1.7 | |
| Green tea extract | 0.34 | |
| Salt | 0.30 | |
| L-Cysteine HCl Monohydrate | 0.042 | |
| Whole wheat flour | 42.77 | |
| Fiber - insoluble wheat (VITACEL | 3 | |
| WF-600/30, J. Rettenmaier, | | |
| Ellwangen/J, Germany) | | |
| Fiber - soluble (Fibersol-2, | 3.5 | 17 |
| Matsutani Chem. Ind., Itami-city | | |
| Hyogo, Japan) | | |
| Isolated Soy Protein | 6 | 3.5 |
| Sodium Bicarbonate | 0.95 | |
| Calcium Phosphate Monobasic | 0.76 | |
| Sodium Aluminum Phosphate | 0.76 | |
| Ammonium Bicarbonate | 2.40 | |
| Whey Protein Isolate | | 11 |
| Vitamin B₁ | 0.0014 | |
| Vitamin B₆ | 0.0024 | |
| Water | 24.01 | |
| Corn Syrup Solids | | 8.5 |
| Cheese Powder | | 24 |
| Cheese Flavor | | 2 |
| Kaomel Flakes | | 3 |

What is claimed is:

1. A composition suitable for use as a food or beverage comprising:
d) one or more flavanols;
e) one or more bracers;
f) vitamin B;
wherein the composition exhibits a Glycemic Index of about 55 or less.

2. A composition according to claim 1 comprising green tea, wherein at least one of the bracers is caffeine.

3. A composition according to claim 2 which is a beverage composition exhibiting a Glycemic Index of about 45 or less.

4. A composition according to claim 3 wherein the beverage composition is a ready-to-drink beverage composition comprising at least about 50% total water, by weight of the composition.

5. A composition according to claim 4 comprising less than about 2% of total free sugars selected from the group consisting of glucose, sucrose, maltose, and mixtures thereof.

6. A composition according to claim 5 wherein at least one of the flavanols is a catechin.

7. A composition according to claim 6 further comprising fructose.

8. A composition according to claim 7 comprising:
a) from about 1 milligram to about 200 milligrams of the total flavanol per every 240 milliliters of the composition; and
b) from about 1 milligram to about 200 milligrams of the total bracer per every 240 milliliters of the composition.

9. A composition according to claim 8 wherein the vitamin B comprises vitamin B₆.

10. A composition according to claim 9 further comprising at least one member selected from the group consisting of complex carbohydrates, soluble fibers, and mixtures thereof.

11. A composition according to claim 10 wherein the composition comprises from about 0.15 milligrams to about 1.5 milligrams of vitamin B_{6,} of the vitamin B₆ per every 240 milliliters of the composition.

12. A composition according to claim 11 comprising from about 0.1% to about 10% of the total fructose, by weight of the composition.

13. A composition according to claim 12 comprising:
a) from about 10 milligrams to about 150 milligrams of the total flavanol per every 240 milliliters of the composition;
b) from about 10 milligrams to about 100 milligrams of the total bracer per every 240 milliliters of the composition; and
c) from about 0.3 milligrams to about 0.9 milligram of the vitamin B₆ per every 240 milliliters of the composition wherein the composition exhibits a Glycemic Index of about 35 or less.

14. A composition according to claim 13 wherein the member is selected from the group consisting of maltodextrins, soluble fibers, and mixtures thereof.

15. A composition according to claim 14 wherein the composition exhibits a Glycemic Index of less than about 45.

16. A composition according to claim 7 comprising a member selected from the group consisting of apple juice, pear juice, agave, and mixtures thereof.

17. A composition according to claim 1 comprising agave.

18. A kit comprising:
a) a composition according to claim 1; and
b) information that use of the composition provides one or more benefits selected from the group consisting of perceived energy, physiological energy, low glycemic benefits, and combinations thereof.

19. A kit comprising:
a) a composition according to claim 7; and
b) information that use of the composition provides one or more benefits selected from the group consisting of perceived energy, physiological energy, low glycemic benefits, and combinations thereof.

20. A method of enhancing the perceived energy of a mammal comprising orally administering a composition according to claim 1 to the mammal.
